(19) United States
(12) Patent Application Publication
(10) Pub. No.: US 2010/0078461 A1
(43) Pub. Date: Apr. 1, 2010

(54) Stapler Gun

(76) Inventor: Roger Shen, Taichung City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/241,128

(22) Filed: Sep. 30, 2008

(51) Int. Cl. B25C 5/00; B25C 5/16

(52) U.S. Cl. 227/129; 227/120

(57) ABSTRACT

A stapler gun comprises a main body, a magazine assembly, a seat assembly, a coil spring and a pressing assembly. The magazine assembly is coupled to the main body and includes a slider rail and a nail holder. The seat assembly is slideably disposed along the slider rail. The coil spring includes first and second ends, with the first end of the coil spring is wound in the seat assembly, and with the second end of the coil spring fixed to the slider rail. The pressing assembly is pivotally connected to the seat assembly and abuts with the nail holder. After feeding a plurality of C type nails on the nail holder, the pressing assembly is abutted against the rear one nail of the C type nails for restricting the C type nails on the nail holder.

### BACKGROUND OF THE INVENTION

1. Field of the Invention

The present invention relates to a stapler gun. In particular, the present invention relates to a stapler gun with a magazine assembly for smooth and easy feed of nails.

2. Description of the Related Art

Referring to FIGS. 6 and 7 a conventional stapler gun 9 includes a main body 91, a magazine 92, a coil spring 93 and a press member 94. The main body 91 includes a coil spring seat 911 and a slide rail 912, with the slide rail 912 having a bent portion and a flat portion, with a first section of the coil spring seat 911 fixed to the main body 91, and with a second section of the coil spring seat 911 fixed to the bent portion of the slider rail 912. The magazine 92 includes an arcuate portion 921 and a flat portion 922, with an end of the arcuate portion 921 fixed to the main body 91, and with another end of the arcuate portion 921 contiguously connected to the end of the arcuate portion 921. The coil spring 93 is wound on the coil spring seat 911. The press member 94 includes a sliding portion 941 slideably disposed along the slide rail 912 and a pressing portion 942 keeping contact with the magazine 92. An end of the coil spring 93 extends from the coil spring seat 911 and couples with the sliding portion 941.

Pull the sliding portion 941 of the press member 94 away from the coil spring seat 911 along the slide rail 912 as to pull the coil spring 93 out of the coil spring seat 911. At the same time, the pressing portion 942 slides along the magazine 92 from the arcuate portion 921 to the flat portion 922.

However, referring to FIG. 7 particularly, during pulling the sliding portion 941 away from the coil spring seat 911, the coil spring 93 is easy to abut against the bent portion of the slide rail 912. Hence, a pull of the coil spring 93 is not smooth and easy because of friction between the coil spring 93 and the slide rail 912.

The present invention is therefore intended to obviate or at least alleviate the problems encountered in prior art.

### SUMMARY OF THE INVENTION

According to the present invention there is provided, a stapler gun comprising

a main body;

a magazine assembly coupled to the main body and including a slider rail and a nail holder;

a seat assembly slideably disposed along the slider rail, and with the seat assembly sandwiched in between the slider rail and the nail holder;

a coil spring including a first end and a second end, with the first end of the coil spring wound in the seat assembly, and with the second end of the coil spring fixed to the slider rail; and

a pressing assembly including a connected section pivotally connected to the seat assembly and a pressing section slideably abutted with the nail holder.

An advantage of the stapler gun is to provide a coil spring disposed in a seat assembly so that the seat assembly is linearly, smoothly, moveably disposed along a slider rail of the magazine assembly, and a pressing assembly is smoothly, moveably disposed along a nail holder of the magazine assembly.

Another advantage of the stapler gun is to provide a first end of the coil spring fixed to and wound in the seat assembly; therefore, the coil spring is rotatable with respect to the seat assembly and linearly extendable as the seat assembly is driven to move along the magazine assembly. This causes the operation of the coil spring smoother and easier.

Other advantages and features of the present invention will become apparent from the following description referring to the drawings.

### BRIEF DESCRIPTION OF THE DRAWINGS

The present invention will be described via detailed illustration of the preferred embodiment referring to the drawings.

FIG. 1 is a perspective view of a stapler gun according to the preferred embodiment of the present invention.

FIG. 2 is an exploded view of the stapler gun shown in FIG. 1.

FIG. 3 is a top view of the stapler gun shown in FIG. 1, illustrating the seat assembly of the stapler gun close to the fastener of the slider rail.

FIG. 4 is a top view of the stapler gun similar to FIG. 3, illustrating the seat assembly of the stapler gun distant from the fastener of the slider rail.

FIG. 5 is another top view of the stapler gun shown in FIG. 1, illustrating a plurality of C type nails fed in the magazine assembly of the stapler gun.

FIG. 6 is a sketch of a conventional stapler gun.

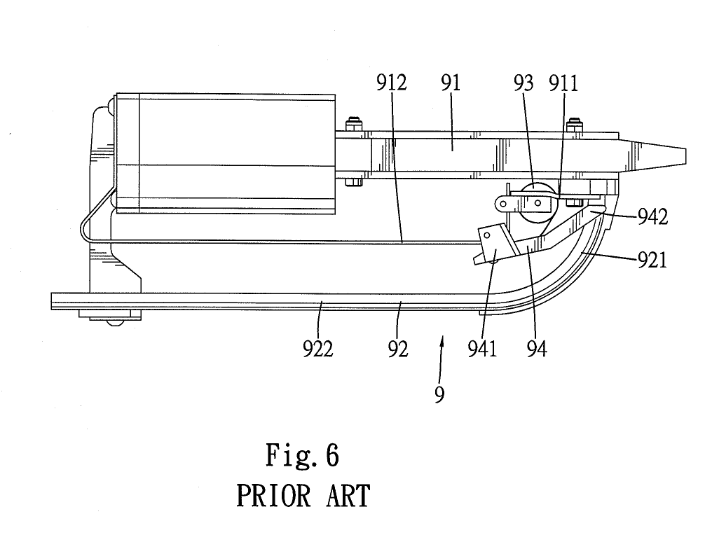

FIG. 7 is another sketch of the conventional stapler gun shown in FIG. 6.

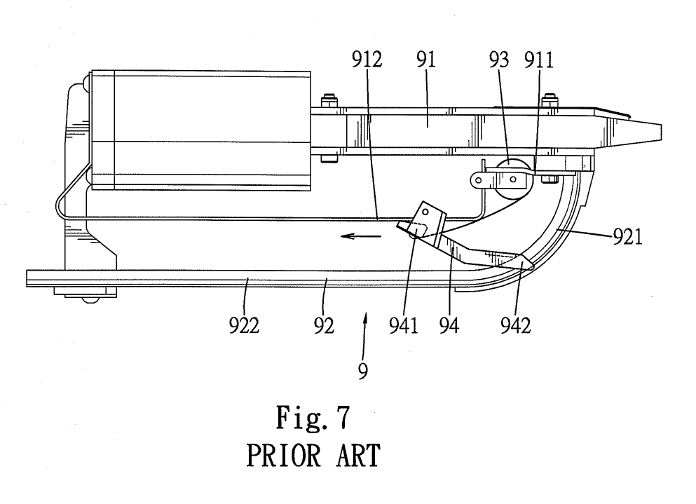

### DETAILED DESCRIPTION OF THE PREFERRED EMBODIMENT

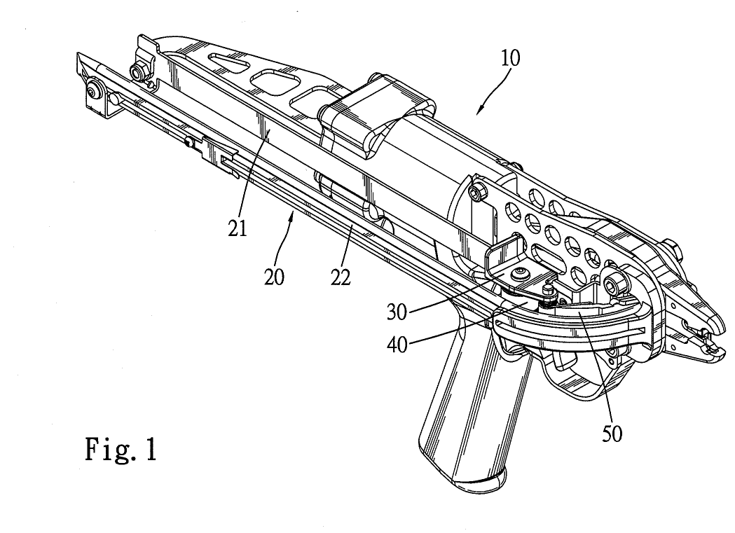

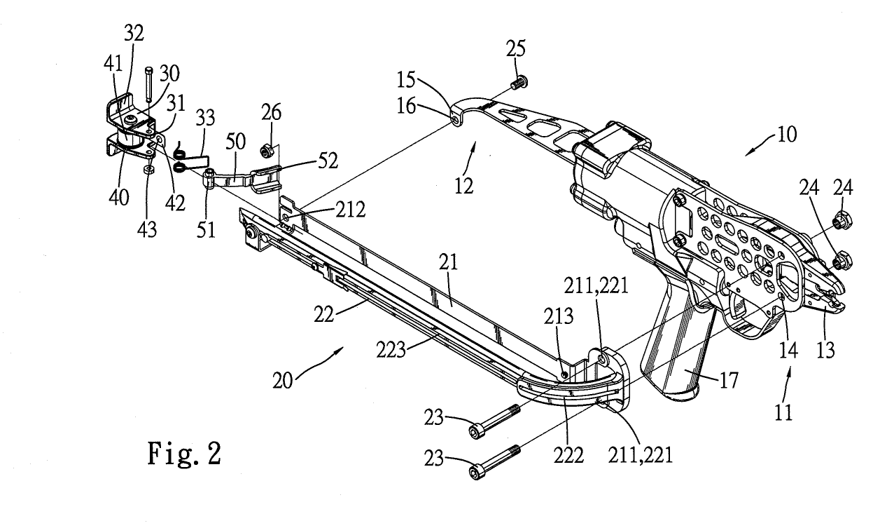

FIGS. 1 and 2 show that a stapler gun includes a main body 10, a magazine assembly 20, a seat assembly 30, a coil spring 40 and a pressing assembly 50.

The main body 10 includes a first section 11 and a second section 12. A firing portion 13 is formed on an end of the first section 11 opposite to the second section 12, and two fixed holes 14 are defined on a side of the first section 11. A coupled portion 15 is longitudinally bent from an end of the second section 12 opposite to the first section 11, and a coupled hole 16 formed on the coupled portion 15. A handle 17 is provided between the first and second sections 11 and 12, with the handle 17 extending longitudinally from the main body 10, and with the handle 17 in order to connect to an electric power supply or a pneumatic power supply.

The magazine assembly 20 includes a slider rail 21 having a first end and a second end and a nail holder 22 having a first end and a second end, with the first ends of the slider rail 21 and nail holder 22 coupled to each other, and with the second end of the slider rail 21 and nail holder 22 parallel to each other approximately. The first end of the slider rail 21 has a bent section and a straight section that contiguously connected to the second end of the slider rail 21. The second end of the slider rail 21 is straight. There is a connector (not numbered) interconnecting the distal of the second ends of the slider rail 21 and nail holder 22. Two fixed holes 211 are defined on the bent section of the first end of the slider rail 21. Two fixed holes 221 are defined on the first end of nail holder 22. The fixed holes 211 and 221 are placed in an overlapping mode. And the fixed holes 14 of the main body 10 correspond to the fixed holes 211 and 221 of the slider rail 21 and nail holder 22. Two bolts 23 and two nuts 24 are provided to connect the fixed holes 14, 211 and 221 to one another. A coupled hole 212 is defined on the second end of the slider rail 21 and corresponds to the coupled hole 16 of the second section 12. A bolt 25 and a nut 26 are provided to connect coupled holes 16 and 212 to each other. The first end of the nail holder 22 further includes an arcuate portion 222 and a flat portion 223, and the arcuate portion 222 is adjacent to the firing portion 13 of the main body 10. A fastener 213 is disposed on and protrudes from the straight section of the first end of the slider rail 21. The fastener 213 is adjacent to the bent section of the first end of the slider rail 21. The seat assembly 30 is slideably disposed along the slider rail 21 of the magazine assembly 20 so that the seat assembly 30 is able to slide along the slider rail 21 between the first and second ends of the slider rail 21. A first section of the seat assembly 30 defines a connected section 31, and a second section of the seat assembly 30 defines an actuation section 32 adapted to be pulled by users. The coil spring 40 is disposed in the seat assembly 30 between the connected and actuation sections 31 and 32 and has a first end 41 and a second end 42. The first end 41 of the coil spring 40 is wound in the seat assembly 30, and the second end 42 of the coil spring 40 extends from the seat assembly 30 and connects to the slider rail 21. A fastening hole 43 is formed on the second end 42 of the coil spring 40 and coupled to the fastener 213 of the slider rail 21. The coil spring 40 keeps contact with the slider rail 21. An elastic element 33 is connected pivotally in the connected section 31 of the seat assembly 30 and has a first section and a second section. A bolt (not numbered) is inserted through two holes (not numbered) on the connected section 31, the first section of the elastic element 33 and the pressing assembly 50 as to connect the pressing assembly 50 with the seat assembly 30. At the same time, the second section of the elastic element 33 is pressed against the pressing assembly 50.

The pressing assembly 50 includes a connected end 51 pivotally connected with the seat assembly 30 and a pressing end 52. The pressing end 52 includes a sliding portion and a distal end opposite to the connected end 51. The cross section of the sliding portion of the pressing end 52 is approximately C-shaped. The second section of the elastic element 33 is pressed between the connected end 51 and the pressing end 52 so that the pressing assembly 50 remains to abut against the nail holder 22 of the magazine assembly 20.

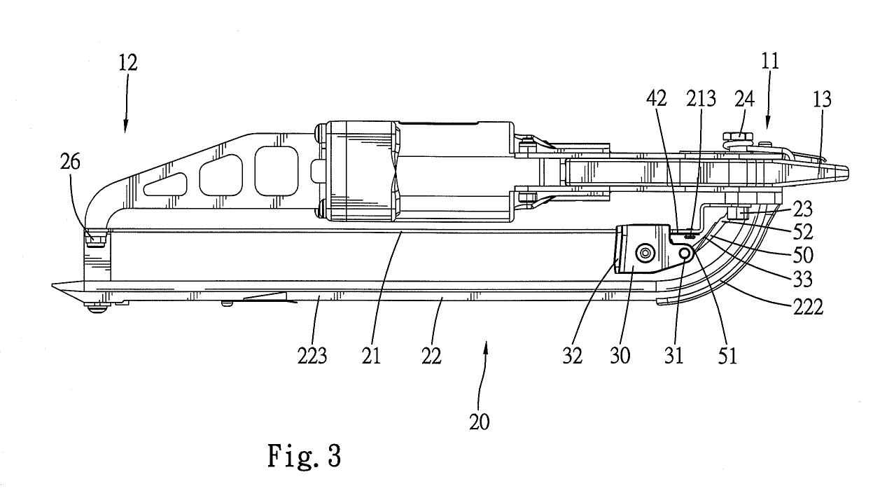

While the stapler gun is in an original mode, referring to FIG. 3, the seat assembly 30 is driven to move toward the fastener 213 of the slider rail 21 by a rebound resilience of the coil spring 40. And, the sliding portion of the pressing assembly 50 is slideably pressed to abut against the nail holder 22 by the second section of the elastic element 33.

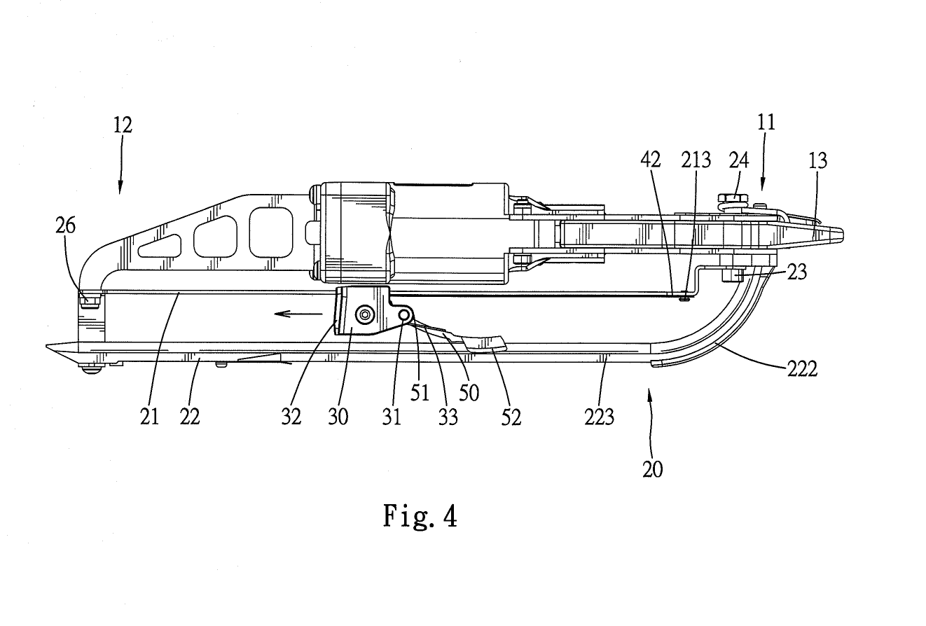

While pulling the actuation section 32 of the seat assembly 30 away from the fastener 213 of the slider rail 21, referring to FIG. 4, the coil spring 40 rotates with respect to the seat assembly 30 and is linearly elongated with the seat assembly 30 from the straight section of the first end of the slider rail 21 to the second end of the slider rail 21. The first end 41 of the coil spring 40 is getting more distant from the fastener 213 of the slider rail 21. And the sliding portion of the pressing end 52 of the pressing assembly 50 still slideably abuts against the nail holder 22.

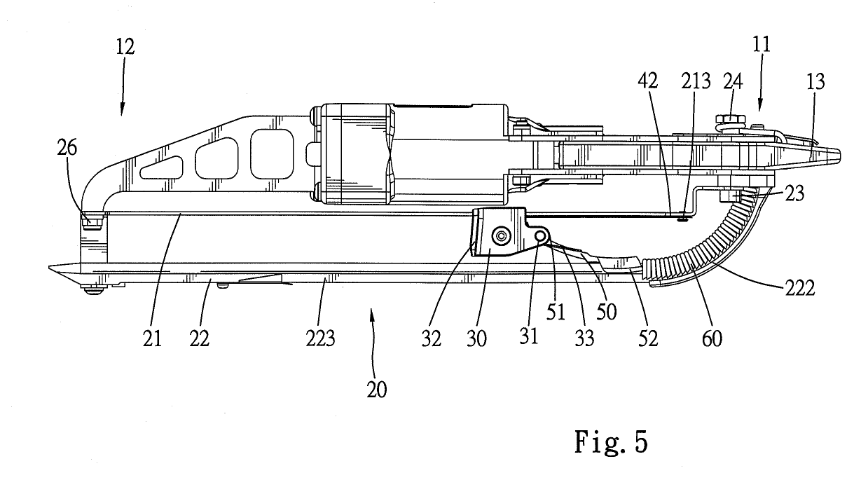

A plurality of C type nails is fed on the nail holder 22, referring to FIG. 5, the distal end of the pressing end 52 of the pressing assembly 50 abuts against the rear one of the C type nails for preventing the disengagement of the C type nails from the nail holder 22. And the sliding portion of the pressing end 52 remains to slideably abut against the nail holder 22.

Thus since the invention disclosed herein may be embodied in other specific forms with out departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come with the meaning and range of equivalency of the claims are intended to be embraced therein.

What is claimed is:

1. A stapler gun comprising:
a main body;
a magazine assembly coupled to the main body and including a slider rail and a nail holder, with the slider rail having a first end and a second end;
a seat assembly slideably disposed along the slider rail, and with the seat assembly sandwiched in between the slider rail and the nail holder;
a coil spring including a first end and a second end, with the first end of the coil spring wound in the seat assembly, and with the second end of the coil spring fixed to the first end of the slider rail; and
a pressing assembly including a connected section pivotally connected to the seat assembly and a pressing section slideably abutted with the nail holder.

2. The stapler gun as claim in claim 1, further comprising a fastener fixed to and protruding from the first end of the slider rail toward the nail holder, and with the second end of the coil spring coupled to the fastener.

3. The stapler gun as claim in claim 2, further comprising a fastening hole defined on the second end of the coil spring, and with the fastening hole coupled to the fastener.

4. The stapler gun as claim in claim 1, wherein the coil spring is rotatable with the seat assembly and the second end of the coil spring is linearly extendable from the seat assembly along the slider rail from the first end of the slider rail to the second end of the slider rail.

5. The stapler gun as claim in claim 1, with the slider rail and the nail holder coupled to each other.

6. The stapler gun as claim in claim 1, wherein the seat assembly further comprises a connected section and an actuation section, with the connected section of the seat assembly connected with the pressing assembly, and with the actuation section of the seat assembly adapted to be pulled by users.

7. The stapler gun as claim in claim 6, further comprising an elastic element provided in the connected section of the seat assembly, and with the elastic element resiliently pressing against the pressing assembly.

8. The stapler gun as claim in claim 6, with the coil spring disposed between the connected end of the seat assembly and the actuated end of the seat assembly.

9. The stapler gun as claim in claim 6, with the connected end of the pressing assembly pivotally connected with the connected section of the seat assembly, and with the pressing end abutted with the nail holder.

10. The stapler gun as claim in claim 8, with the connected end of the pressing assembly pivotally connected with the connected section of the seat assembly, and with the pressing end abutted with the nail holder.

11. The stapler gun as claim in claim 9, with a cross section of the pressing end of the pressing assembly being C-shaped.

12. The stapler gun as claim in claim 10, with a cross section of the pressing end of the pressing assembly being C-shaped.

13. The stapler gun as claim in claim 1, further comprising a firing portion provided on the main body.

14. The stapler gun as claim in claim 1, further comprising a handle provided between a first end and a second end of the main body.
